(19) United States
(12) Patent Application Publication
(10) Pub. No.: US 2008/0057858 A1
(43) Pub. Date: Mar. 6, 2008

(54) WIRELESS TRANSCEIVER WITH RETRACTABLE BYPASS CORD

(76) Inventor: Dale Trenton Smith, San Jose, CA (US)

Correspondence Address: R. BURNS ISRAELSEN;Workman Nydegger, 1000 Eagle Gale Tower, 60 E. South Temple, Salt Lake City, UT, 84111, US

(21) Appl. No.: 11/469,545

(22) Filed: Sep. 1, 2006

(51) Int. Cl. H04H 1/00

(52) U.S. Cl. 455/3.05

(57) ABSTRACT

The present invention relates to a wireless communication system. The wireless communication system includes a wireless headset or handset, a wireless transceiver configured to communicate with the wireless headset or handset over a wireless audio signal path, and a retractable bypass cord integrated with the wireless transceiver that is configured to connect the wireless transceiver with the wireless headset or handset such that the wireless audio signal path is bypassed with a wired audio signal path.

### CROSS-REFERENCE TO RELATED APPLICATIONS

Not applicable.

### BACKGROUND

Aviation headgear is used by professional and private pilots throughout the world. The purpose of this headgear is to enable the pilot to communicate with the ground and with the co-pilot unimpeded by background noise. Most general aviation aircraft were originally built with a hand held microphone and a speaker mounted in the cabin. Over the last thirty years, however, headsets with speakers built into ear cups or pieces and mounted microphones have become the norm. These headsets reduce ambient noise, thus allowing for improved hearing by a user. These headsets also allow for hands free communication by way of the microphone. Typically, such headsets are wired to the aircraft communication system with a cord and jack assembly. These types of headsets are also commonly used in fire trucks and other such emergency vehicles where communication between a crew is required.

The cord from such wired headsets, however, often may get in the way of a user's movement, and is frequently responsible for pulling the headset from its most comfortable position on the user's head. In small aircraft where passengers and crew sit close together, it is common for one person's movement to cause a pull on his or her own or another person's headset cord. Often, the plugs on the end of a headset cord become intermittent due to the frequent strain put on them when users accidentally pull on or sit on the cord. In larger aircraft or in emergency vehicles, a cord can interfere with the responsibilities of crew members, so headsets are removed and communication sacrificed while some duties are performed.

Wireless headsets and related communication systems have been developed to solve the problems created by the cord of the wired headsets. However, existing wireless headsets introduce other problems which often limit their use in noisy environments and environments where communications are critical, such as in an aircraft or emergency vehicle. For example, one limitation of existing wireless headsets is that they typically rely on batteries and will lose power if the batteries are not recharged or replaced. The exclusive use of battery power causes many existing wireless headsets to not use Active Noise Reduction (ANR), as ANR consumes more battery power. ANR, however, provides improved communications and reduces fatigue in noisy environments. In addition, the battery status is often provided with visual indicators such as Light Emitting Diodes which are insufficient to capture the user's attention when pilot or crew workload is high.

A further limitation of existing wireless headsets and related communication systems is that the radio or intercom in an aircraft or vehicle must be adapted for wireless headset communications by adding a wireless transceiver in an unobtrusive location. Most existing wireless transceivers provide cords for plugging into a radio or intercom, but the user must come up with a mounting location and method if they want to prevent the transceiver from dangling or shifting about the cabin. In addition, the wireless transceiver requires power and therefore needs custom installation, a power socket, or batteries, which are a potential source of communication failure if the batteries are not recharged or replaced.

Another limitation of existing wireless headsets and related communication systems is the available license-free RF bandwidth available when multiple wireless headsets are used in an aircraft or vehicle. Passengers and crew often use stereo headsets to listen to music during long trips. Stereo requires an additional audio channel and additional power and RF bandwidth for a wireless headset. Existing stereo wireless transceivers require stereo inputs, and are unable to transmit a single mono input to two stereo outputs when used with a mono source.

In addition, stereo transceivers running in UHF or higher frequency license-free bands typically incur large delays (>20 ms) associated with compressing, packetizing, de-packetizing, and decompressing the audio. This causes an unacceptable echo to the user when the radio or intercom provides sidetone, which allows the user to hear their own voice through the headphone. Stereo transceivers in VHF bands using FM stereo are subject to interference from other transmitters.

### BRIEF SUMMARY

The principles of the present invention relate to a wireless transceiver with a retractable bypass cord. The wireless transceiver may be used to transmit audio and power signals to a wireless headset or handset.

One embodiment of the present invention relates to a wireless communication system. The wireless communication system includes a wireless headset or handset, a wireless transceiver configured to communicate with the wireless headset or handset over a wireless audio signal path, and a retractable bypass cord integrated with the wireless transceiver that is configured to connect the wireless transceiver with the wireless headset or handset such that the wireless audio signal path is bypassed with a wired audio signal path.

A second embodiment of the present invention relates to a wireless communication system. The wireless communication system includes a wireless transceiver configured to communicate with a wireless headset or handset over a wireless audio signal path and a detachable tether system coupled to the wireless transceiver.

A third embodiment of the present invention relates to a wireless transceiver for use in wireless communication with a wireless headset or handset. The wireless transceiver includes an integrated retractable bypass cord configured to connect the wireless transceiver with the wireless headset or handset such that a wireless audio signal path is bypassed with a wired audio signal path, a first connector for receiving a connector of the retractable bypass cord, and one or more second connectors coupled to the retractable bypass cord or the wireless transceiver for receiving audio and power signals from an external radio or intercom that are to be transmitted to the wireless headset or handset.

A further embodiment of the present invention relates to a wireless transceiver for use in wireless communication with one or more wireless headsets or handsets. The wireless transceiver includes an integrated retractable bypass cord configured to connect the wireless transceiver with the one or more wireless headsets or handsets such that a wireless audio signal path is bypassed with a wired audio signal path, detection circuitry for detecting when the retractable bypass cord is coupled to one of the one or more headsets or handsets, and one or more connectors coupled to the wireless transceiver for receiving audio and power signals that are to be transmitted to the one or more wireless headsets or handsets from an external radio or intercom

Embodiments disclosed herein also relate to a wireless transceiver that includes a microprocessor for executing software configured to provide status messages regarding operational parameters of the wireless transceiver to a user of the wireless transceiver. The wireless transceiver performs a method for inserting status messages regarding the operation parameters without interrupting normal communication of the wireless transceiver. The method comprises determining if there is a pending status message, determining if any normal audio communications are present, in response to determining that normal audio communications are present, not inserting the status message until the normal audio communications are complete, and in response to determining that normal audio communications are not present, inserting the status message into an audio communication.

Further embodiments disclose a wireless communication system comprising a wireless transceiver one or more connectors coupled to the wireless transceiver via electrical cords, and a transceiver housing configured to mechanically secure the wireless transceiver to a housing of at least one of the one or more connectors.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows, and in part will be obvious from the description, or may be learned by the practice of the embodiments disclosed herein. The features and advantages of the embodiments disclosed herein may be realized and obtained by means of the instruments and combinations particularly pointed out in the appended claims. These and other features of the embodiments disclosed herein will become more fully apparent from the following description and appended claims, or may be learned by the practice of the embodiments disclosed herein as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a diagram of a wireless headset system with a retractable cord integrated into the wireless transceiver;

FIG. 2 is a detailed drawing of the latch used by the wireless headset to secure a bypass cord and wireless transceiver;

FIG. 3 is a detailed drawing of the tether used by the retractable bypass cord to secure the bypass cord and wireless transceiver when the bypass cord is pulled out;

FIG. 4 is a diagram of a retractable bypass cord for the wireless transceiver supporting a single headset;

FIG. 5 is a detailed drawing of a wireless transceiver supporting a single wireless headset;

FIG. 6 is a detailed drawing of a wireless transceiver with integrated intercom functions for use with multiple wireless headsets;

FIG. 7 is a drawing of a wireless transceiver with cylindrical hole for attaching the transceiver to a plug;

FIG. 8 is a block diagram of the power management circuits and major components of the wireless headset;

FIG. 9 shows details of the Digital Stereo Transmitter and Digital Stereo Receiver;

FIG. 10 shows the format of status message packets; and

FIG. 11 shows the sequence of steps used to insert status messages without interrupting communications.

### DETAILED DESCRIPTION

The principles of the present invention relate to a wireless headset system that may be integrated with a variety of diverse systems, consisting of radios, intercoms and audio selectors. These may provide stereo or mono sound. Some headsets, such as in aircraft or emergency vehicles, need to communicate through VHF radios while other headsets on the same intercom do not. Some headsets in a system may be mission critical, while others in the same system are for entertainment purposes. A wireless headset system may consist of a single headset, or multiple headsets communicating with each other.

A wireless headset system typically consists of both the wireless headset and a wireless transceiver which converts wired audio signals to wireless. Generally, the wireless transceiver must adapt the wireless headset to the specific operating requirements of a particular audio system. One embodiment of the wireless headset system consists of a single wireless headset design which can be coupled with different wireless transceivers to support a variety of audio installations.

One such installation may be the pilot of a single-seat acrobatic aircraft who uses his headset to communicate with Air Traffic Control (ATC). In this example, there are no other headsets and no intercom features. A retractable bypass cord is part of the wireless transceiver and is used to plug into the wireless headset should any portion of the wireless system fail. The wireless transceiver must be mounted very securely since the pilot may roll or loop the aircraft.

Another installation is a six-seat aircraft with a pilot and copilot who both need to talk to ATC. In this example it is desirable for all six seats to have wireless headsets, with the crew talking to ATC and sometimes talking to the passengers, and the passengers listening to stereo music and talking to each other, and sometimes talking to the crew when enabled by the crew. In this case, a wireless transceiver would support all six headsets and include integrated intercom functions with the ability to integrate or segregate headsets groups. However, only the pilot and copilot need the reliability provided by the bypass cord, and if one of them uses the bypass cord the other should be able to continue wireless communications. Explanations of the design differences which enable the invention to be used in these varied applications will be discussed.

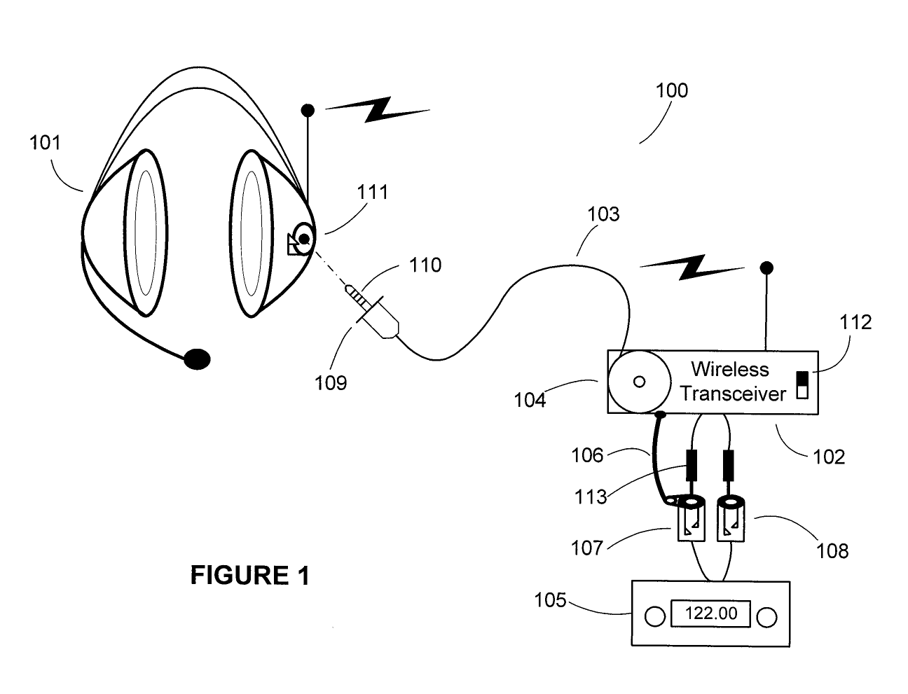

Referring first to FIG. 1, a wireless communication system 100 is illustrated. Communication system 100 includes a wireless headset 101 that communicates wirelessly with a wireless transceiver 102 with integrated retractable bypass cord 103. The wireless transceiver 102 with integrated retractable bypass cord 103 receives electrical audio signal(s) from a radio or intercom 105 through a headphone jack 107 and transmits the audio signal(s) wirelessly to the wireless headset 101. The wireless transceiver 102 with integrated retractable bypass cord 103 also receives mono voice transmissions from the wireless headset 101 and forwards those to the radio or intercom 105 through a microphone jack 108.

As mentioned, the wireless transceiver 102 includes an integrated retractable bypass cord 103 which may be pulled out by the wearer of the wireless headset 101 and plugged into the wireless headset 101 should the batteries powering wireless headset 101 die or any other failure occur with either the wireless headset 101 or wireless transceiver 102 with integrated retractable bypass cord 103. The retractable bypass cord 103 may be stored in the wireless transceiver 102 using a retracting cord reel 104. Retractable cord reels such as retractable cord reel 104 are well known in art such as those disclosed in U.S. Pat. No. 6,616,080. The retractable cord reel 104 allows the retractable bypass cord 103 to be withdrawn by simply pulling on it. The retractable cord reel 104 includes a retract button (not illustrated) which allows it to pull the retractable bypass cord 103 back inside when the retract button is pressed by a user. This feature helps ensure that the retractable bypass cord 103 has some slack so that it does not pull on the wireless headset 101 when the retract button is not pressed.

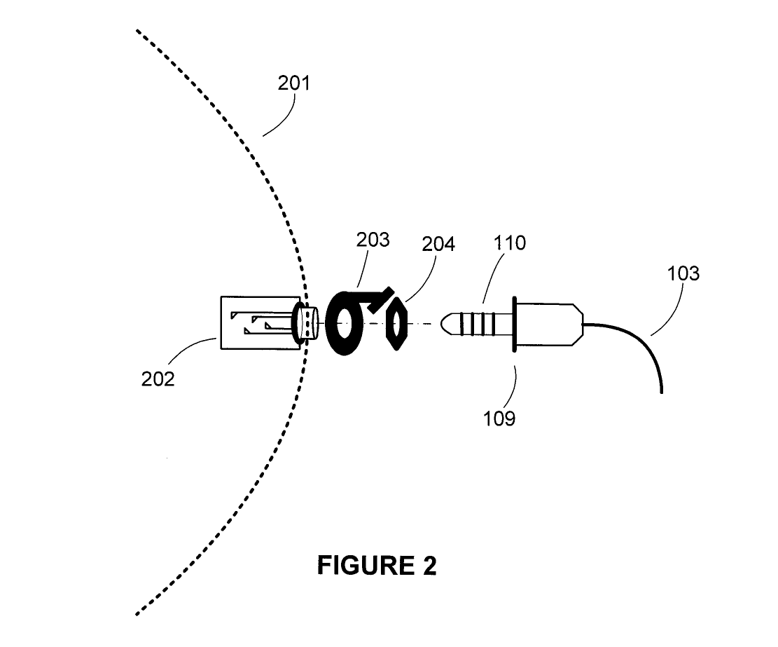

The connection between the wireless headset 101 and the retractable bypass cord 103 is performed by a novel latching plug and jack architecture as will be described in more detail to follow in relation to FIG. 2. Briefly, a 5-conductor plug 110 provides 5 cylindrical conductors stacked along its shaft. A 5-conductor jack with latch 111 provides 5 contacts aligned to connect to the 5 cylindrical conductors in the 5-conductor plug 110 when it is inserted. Thus, the connection is made correctly regardless of the rotational angle of the insertion of the 5-conductor plug 110. Advantageously, by eliminating the need to rotate the connector correctly, the user can make the connection to the headset without removing the headset from his or her head or looking at the jack before connecting it.

The wireless transceiver 102 with retractable cord 103 uses a stereo headphone plug 113, which may be plugged into either a stereo or mono headphone jack 107. When plugged into a mono headphone jack 107, one conductor on the plug 113 will be open so that one of the stereo inputs to the wireless transceiver 102 with integrated retractable bypass cord 103 is not driven. The wireless transceiver 102 with integrated retractable bypass cord 103 may also include a stereo/mono switch 112 which, when in the mono position, shorts the left and right audio signals together from the headphone jack 107 so that its mono signal drives both the left and right stereo signal inputs on stereo headphone plug 113. When the stereo headphone plug 113 is plugged into a stereo headphone jack 107, the stereo/mono switch 112 is placed in the stereo position, which does not short the right and left stereo inputs together.

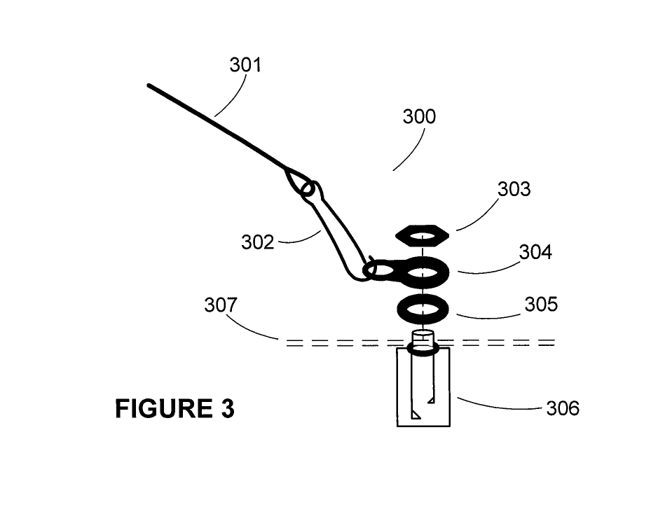

The wireless communication system 100 also includes a tether 106 that is configured to ensure that the plugs from the wireless transceiver 102 with integrated retractable bypass cord 103 are not pulled out of the headphone jack 107 and microphone jack 108 when the user grabs the retractable bypass cord 103 in order to insert the 5-conductor plug 110 into the wireless headset 101. More detail on the tether 106 will be described below in relation to FIG. 3.

FIG. 2 shows detail of a 5-conductor jack with latch 202 that may correspond to the 5-conductor jack with latch 111 of FIG. 1. The 5-conductor jack 202 is mounted within a headphone ear cup 201 on one side of the wireless headset such as wireless headset 101. A spring-steel jack latch 203 is attached to the 5-conductor jack 202 using a nut 204 that also attaches the 5-conductor jack 202 to the headphone ear cup 201. The spring-steel jack latch 203 is angled such that the insertion of the 5-conductor plug 110 pushes the latch aside momentarily until a latch ring 109, which may be a simple ring similar to a washer that is placed on the 5-conductor plug 110 and held in place by the plug's housing, passes by the spring-steel jack latch 203. The spring-steel jack latch 203 then snaps back to its normal position holding the latch ring 109 and 5-conductor plug 110 securely in place. To remove the 5-conductor plug 110, the user must bend the spring-steel jack latch 203 out of the way, and then withdraw the 5-conductor plug 110 from the 5-conductor jack with latch 202. It is also anticipated that in some embodiments, the latch 203 may be attached to the 5-conductor plug 110 and the latch ring 109 may be attached to the jack 202.

FIG. 3 shows detail of a tether 300 that may correspond to the tether 106 of FIG. 1. The tether 300 may include a tether cord 301 which may be coupled to the wireless transceiver 102 with integrated retractable bypass cord 103. The tether 300 may also include a tether clip 302 that is configured to be clipped to a tether washer 304, or other mechanically secure location. The tether washer 304 advantageously provides an easy way for users to create a secure clip point by unscrewing a nut 303 and placing the tether washer 304 on the headphone or mic jack 306 and then screwing the nut 303 back on again. A washer 305 is included to ensure that the tether washer 304 has enough clearance from a vehicle panel 307 that the tether clip 302 can be easily clipped on. The tether washer 304 may easily be installed in each aircraft or vehicle the user intends to use the wireless headset in.

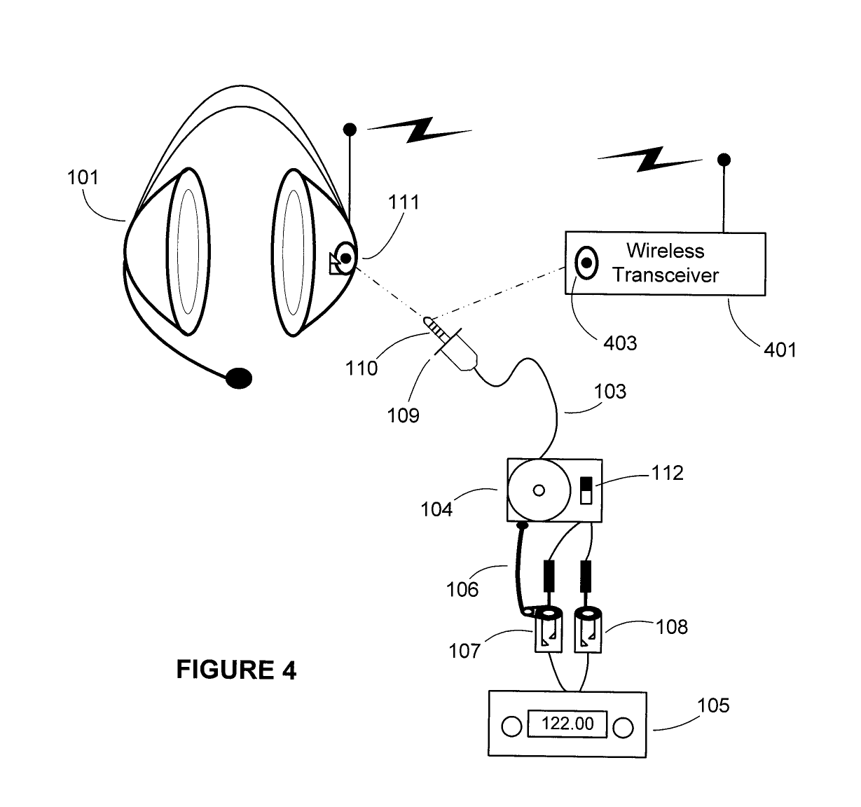

Turning now to FIG. 4, an example embodiment illustrates how the retractable bypass cord 103 may be used in series with a wireless transceiver 401, which may correspond to wireless transceiver 102 of FIG. 1. In this example embodiment, the retractable bypass cord 103 and retracting cord reel 104 are shown as separate from the wireless transceiver 401 to aid in the understanding of the serial nature of the cord connection to the wireless transceiver 401. However, the retractable bypass cord 103 and retracting cord reel 104 may still be physically integrated within the enclosure of the wireless transceiver 401, as is illustrated by the wireless transceiver 102 with integrated retractable bypass cord 103 of FIG. 1.

In the case of a serial retractable cord 103, a user must disconnect the 5-conductor plug 110 from a jack without latch 403 in the wireless transceiver 401 in order to plug it into the 5-conductor jack with latch 111 of the wireless headset 101. An advantage of placing the serial retractable cord 103 in series with the wireless transceiver 401 instead of in parallel is that the serial retractable cord 103 is used and tested during wireless operation, thus eliminating the need for the user to occasionally test the retractable bypass cord 103 to ensure it will work in an emergency or other bypass situation.

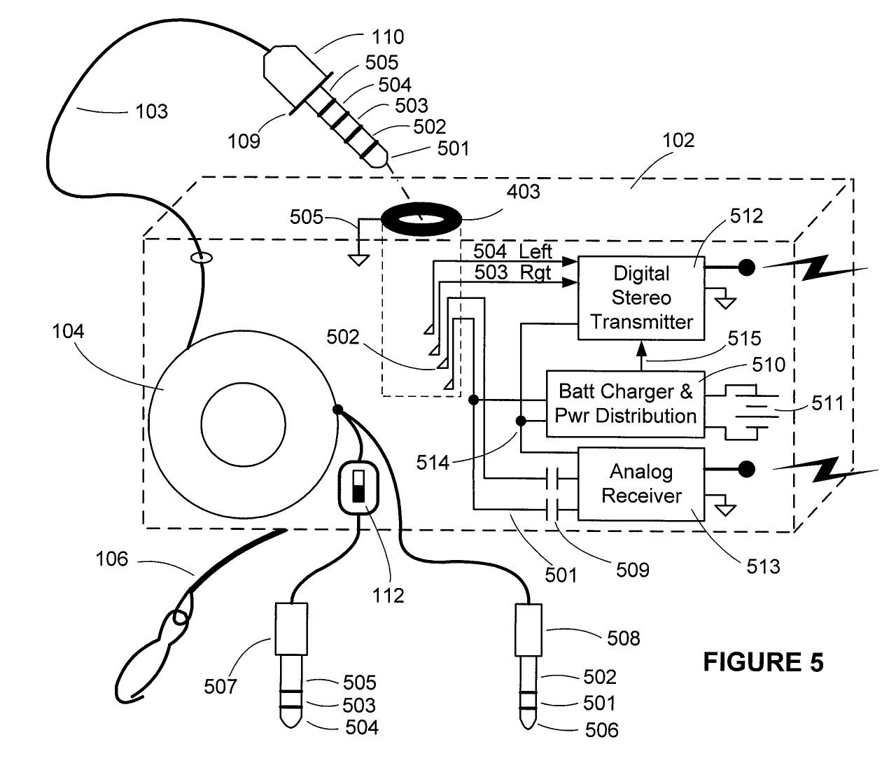

FIG. 5 illustrates a block diagram of the major functional blocks of an embodiment of a wireless transceiver 102 with integrated retractable bypass cord 103, and also shows the signal detail for the retractable bypass cord 103. The retractable bypass cord 103 shown in FIG. 5 is in series with the wireless transceiver 102; however the signals and conductors in the 5-conductor plug 110, headphone plug 507, and microphone plug 508 are the same as for a retractable bypass cord 103 in parallel with a wireless transceiver 102.

The headphone plug 507 may be plugged into the mono headphone jack 107 of a communications radio, or into the stereo jack from an intercom or other device that provides stereo sound. The stereo/mono switch 112 is used to ensure that both the left and right inputs receive audio signal if headphone plug 507 is plugged into a mono jack or a stereo jack. The tip of the headphone plug 507 is the left speaker 504 input, or the mono input when plugged into a mono jack. The center conductor is the right speaker 503 input. The innermost conductor is the speaker return 505 which provides the DC reference level for the right speaker 503 and left speaker 504 signals. These three headphone signals are carried by the retractable bypass cord 103 to the 5-conductor plug 110 for connection to the wireless headset 101 as illustrated.

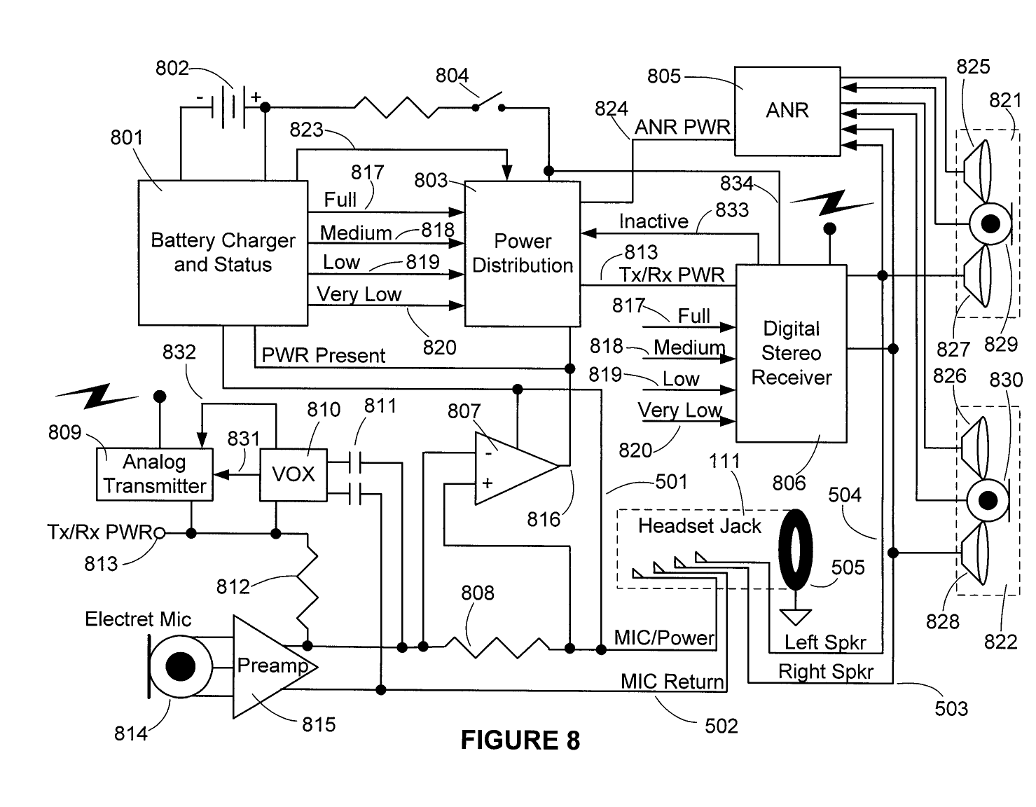

The microphone plug 508 is plugged into the microphone jack 108 of the radio or intercom 105. The tip of the microphone plug 508 is the Push-To-Talk 506 signal, which is not used by the wireless headset since it is usually provided by a hardwired push-button in the vehicle or on the aircraft's yoke. The center conductor is the MIC/Power 501 signal which provides power from the radio or intercom 105 to the microphone preamp 815 (FIG. 8) and carries the amplified voice signal from the electret microphone 814 (FIG. 8) to the radio or intercom 105. The innermost conductor is the MIC Return 502 signal which provides the DC and AC reference level for the microphone preamp 815. The MIC/Power 501 and MIC Return 502 signals are carried by the retractable bypass cord 103 to the 5-conductor plug 110 for connection to the wireless headset 101 as illustrated.

An analog receiver 513 receives voice transmissions from the wireless headset 101, and converts them to electrical signals. The signals are provided to the radio or intercom 105 through the retractable bypass cord 103 and the microphone plug 508 via the MIC/Power 501 and MIC Return 502 signals. The transceiver DC blocking capacitors 509 isolate the analog receiver's 513 output driver and ground from the DC bias voltage present on the MIC/Power 501 signal, and eliminate ground loop noise on the MIC Return 502 signal.

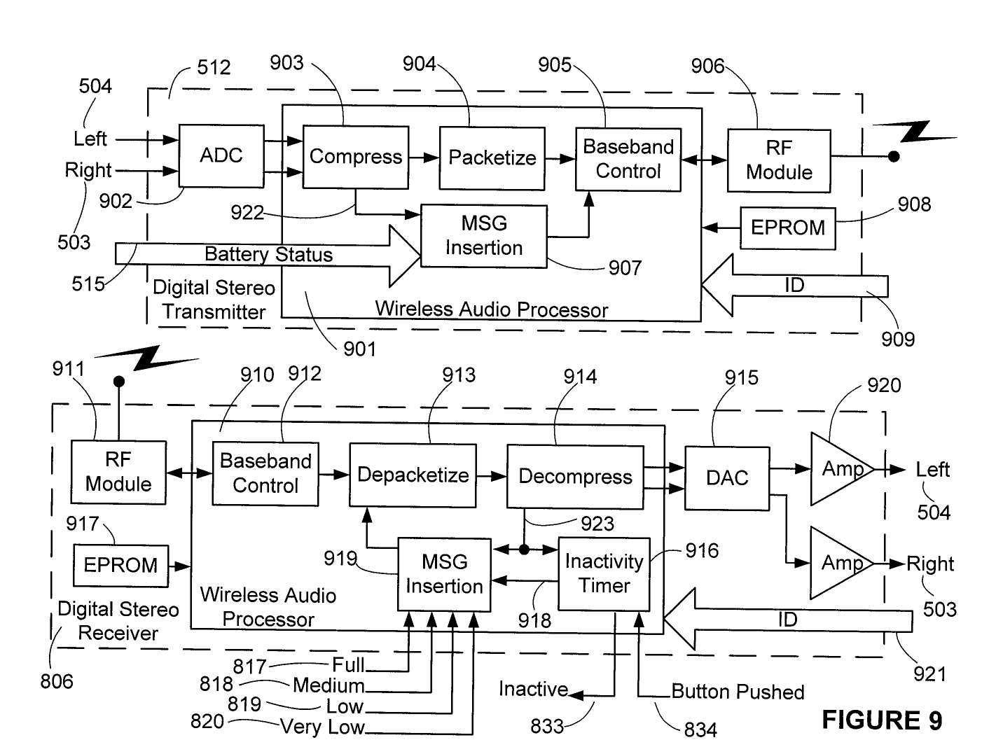

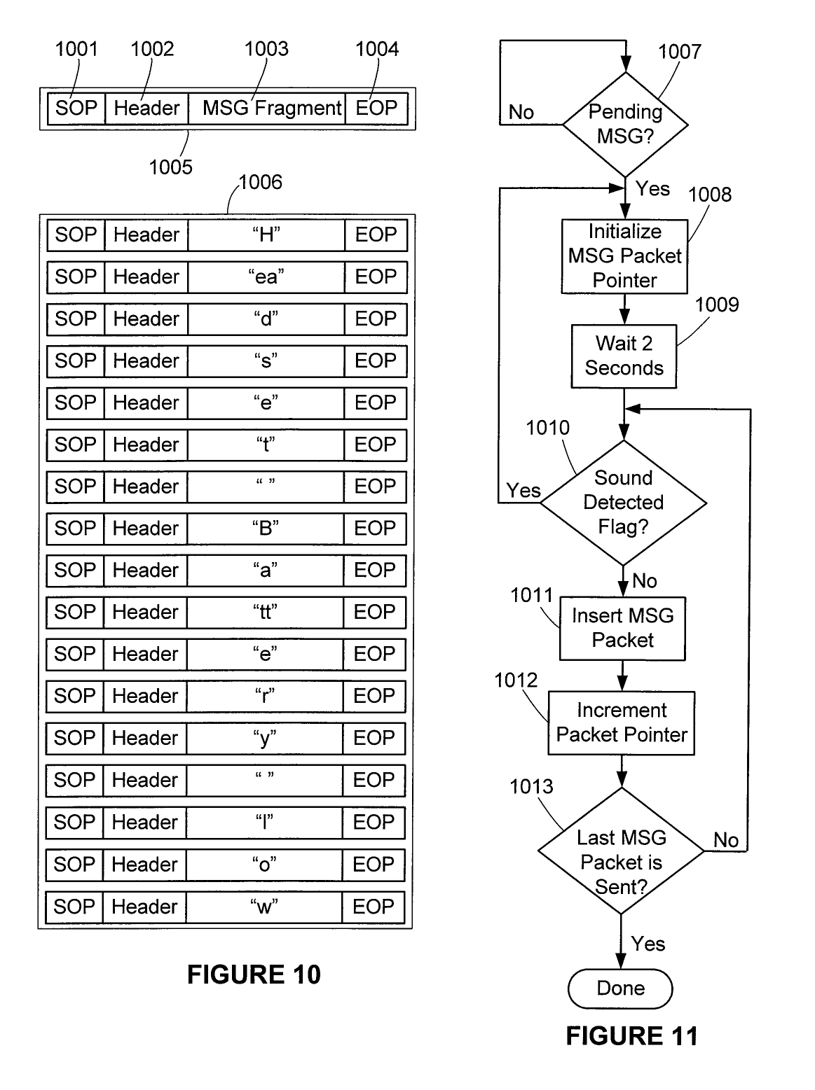

A Digital Stereo Transmitter 512 receives left speaker 504 and right speaker 503 mono or stereo electrical audio signals from the radio or intercom 105 through the headphone plug 507. It then compresses and packetizes the audio signals for wireless transmission to the wireless headset 101 using common digital wireless technology such as Bluetooth. The Digital Stereo Transmitter also receives battery status signals 515 from a battery charger and power distribution module 510. The battery status signals 515 provide the Digital Stereo Transmitter 512 with battery charge status conditions such as Full, Medium, Low, or Very Low charge. The Digital Stereo Transmitter 512 uses these signals to trigger the insertion of battery status messages into the outgoing audio transmission so that the wearer of the wireless headset 101 is notified that the transceiver battery 511 is low, and notified that he or she should pull out the retractable bypass cord 103 and insert it into the wireless headset 101. FIG. 9 and FIG. 10 discussed below provide more detail on how these audio messages are inserted without interrupting communications with ATC or other source.

The battery charger and power distribution module 510 charges the transceiver battery 511 using the power input from the MIC/Power 501 signal, which come from the radio or intercom 105, or from a dedicated power supply which provides power using a jack compatible with the microphone plug 508. Battery charging circuitry, which is well known in the art, is used to ensure that the battery charger and power distribution module 510 does not overcharge the battery 511. The battery charger and power distribution module 510 draws as much current as the transceiver battery 511 needs to charge quickly and safely, or the maximum current the power supply or MIC/Power 501 provides, whichever is smaller. MIC/Power 501 from the radio or intercom 105 typically provides 12V through a 1K ohm resistor, limiting the current to about 6 mA usable at 6V. The battery charger and power distribution module 510 uses a 6V zener diode as a voltage reference for a voltage regulator to set the voltage drop from the MIC/Power 501 so that the maximum possible current is drawn from MIC/Power 501 without drawing so much current that the MIC/Power 501 voltage drops below the 6V needed to supplement the transceiver battery 511. Typically, 6 mA is enough to supplement the transceiver battery 511 and lengthen the operating time of a battery powered transceiver, but is not enough to charge the transceiver battery 511 while the wireless transceiver 102 with integrated retractable bypass cord 103 is in use. When connected to a higher current MIC/Power 501 source such as a power supply, the battery charger and power distribution module 510 may draw sufficient current to quickly and safely charge the transceiver battery 511.

The battery charger and power distribution module 510 detects the presence of voltage on MIC/Power 501 and uses that power to power up the battery charger and power distribution module 510 circuits. Then, if the battery charger and power distribution module 510 detects sufficient voltage from the transceiver battery 511, it powers up the digital stereo transmitter 512 and analog receiver 513 by enabling current flow between the transceiver battery 511 and the transceiver power 514 using a relay or solid state device such as a transistor (not illustrated). Thus, the wireless transceiver 102 with integrated retractable bypass cord 103 typically does not need a power switch and will automatically power up whenever voltage is present on MIC/Power 501 and sufficient voltage is present from the transceiver battery 511. In addition to providing transceiver battery status 515 to the digital stereo transmitter 512, the battery charger and power distribution module 510 also drive LEDs (not illustrated) that provide visual status of transceiver battery 511 power.

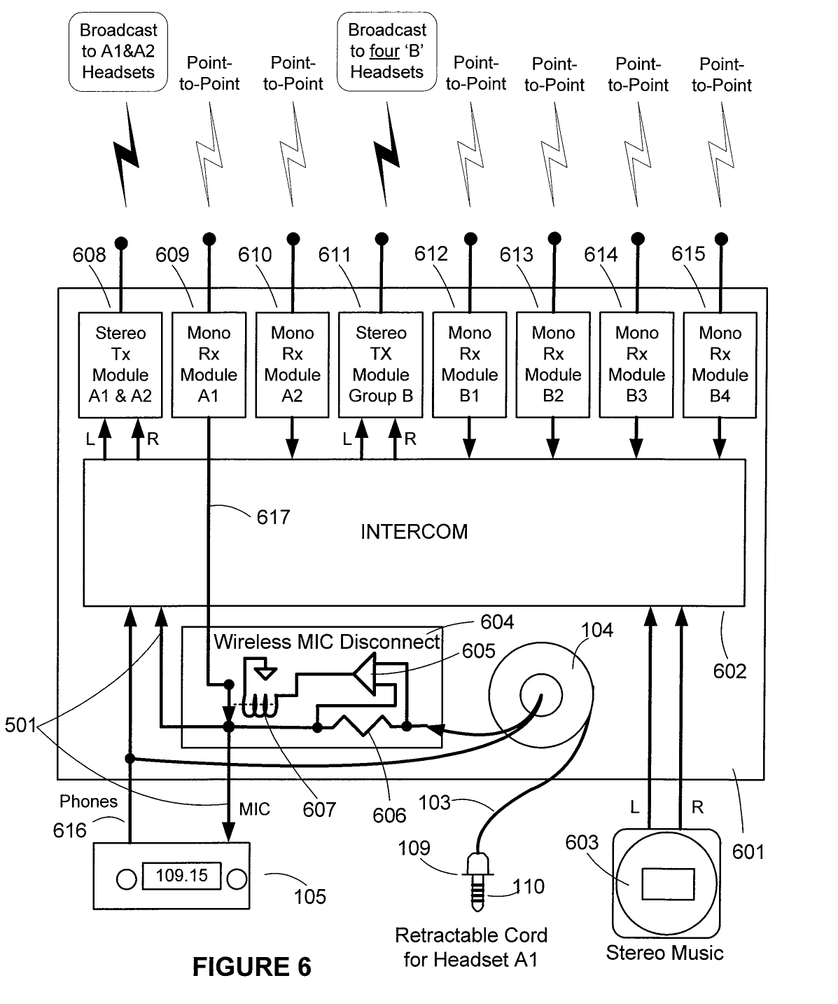

Referring now to FIG. 6, a wireless transceiver/intercom 601 which may provide intercom features using wireless headsets 101 in an aircraft or vehicle without an installed intercom is illustrated. Wired intercoms are well known in the art and at a minimum provide headsets with the ability to talk to each other. Wired intercoms also provide the ability to mute all microphones except the microphone associated with a currently pressed push-to-talk button. This ensures that radio transmissions come only from the voice intending to transmit. Like many radios, advanced wired intercoms can also provide mono or stereo background music or other entertainment audio which is muted when someone speaks. Advanced wired intercoms also provide the ability to use a cell phone with one or more headsets. Advanced wired intercoms further provide a feature for segregating the headsets into groups, so that members of each group can only hear other members of their group. Aircraft wired intercoms often have three group settings called “Pilot Isolate”, “Crew”, and “All”. The “Pilot Isolate” setting isolates the pilot and the VHF radio into one group, while letting everyone else in the second group talk to each other. The “Crew” setting creates two groups where one group consists of the crew and VHF radio and the second group consists of the passengers. The “All” setting puts everyone and the VHF radio in the same group.

Within the wireless transceiver/intercom 601 there may be an intercom 602 which incorporates the features of advanced wired intercoms such as background audio and grouping modes. The background music is provided by an external music player 603, which may be a DVD or MP3 player. Wired intercom technology is well known and is incorporated by replacing the microphone inputs from a typical wired intercom with Mono Rx Modules 609, 610, 612, 613, 614, and 615. Also, the headphone outputs of a typical wired intercom are replaced by Stereo TX Modules 608 and 611, which in some embodiments may provide stereo audio broadcast to the “Crew” group (Group A) and the “Passenger” group (Group B).

When the “Crew” mode of segregation is chosen, Mono Rx Modules 609 and 610 are microphone inputs from the “Crew” group (Group A) and Mono Rx Modules 612, 613, 614, and 615 are microphone inputs from the “Passenger” group (Group B). Also, when “Crew” mode is chosen Stereo Tx Module A1&A2 608 provides broadcast transmission to the pilot (A1) and copilot (A2) wireless headsets. By using a broadcast transmission for Group A, and another broadcast transmission for Group B, all headsets are able to hear everyone in their respective groups and RF bandwidth requirements are minimized, making it possible to support all headsets with high fidelity stereo audio with the limited bandwidth available in license-free RF bands. On the other hand, when “All” mode is chosen, all headsets are integrated into a single group and Stereo Tx Module A1&A2 608 and Stereo Tx Module Group B 611 are provided with the same audio by intercom 602 so that everyone hears the same thing.

The wireless transceiver/intercom 601 may also contain a single retractable bypass cord 103 for use by the pilots (A1) wireless headset 101. Since multiple wireless headsets 101 are supported by the single wireless transceiver/intercom 601, the wireless transceiver/intercom 601 uses a parallel retractable bypass cord 103 instead of a serial retractable bypass cord, so that the integrated intercom 602 can continue to perform normally for all headsets when the parallel retractable bypass cord is used by the pilot. A Wireless Mic Disconnect 604 ensures that when the pilot plugs the parallel retractable bypass cord 103 into his or her wireless headset 101, the MIC/Power 501 signal into the radio or intercom 105 is not driven by both the wired MIC/Power signal 501 from the parallel retractable bypass cord 103 and the A1 Rx Mic Signal 617 from Mono Rx Module A1 609.

The Wireless Mic Disconnect 604 senses that the retractable bypass cord 103 has been plugged into the wireless headset 101 by detecting the current being drawn from the MIC/Power 501 signal by the preamp 815 (FIG. 8) in the wireless headset 101. The current drawn by the preamp 815 causes a small voltage drop across a low ohm resistor 606, which is in series with the MIC/Power 501 from the retractable bypass cord 103. The small voltage drop is detected by a comparator 605, which then discontinues driving the coil of a Mic Disconnect Relay 607, thus disconnecting the output of Mono Rx Module A1 609 from the MIC/Power 501 signal input to intercom 602. Accordingly, the MIC/Power 501 signal from the retractable bypass cord 103 becomes the only signal to drive the microphone input of the intercom 602 and radio or intercom 105 when the retractable bypass cord 103 is plugged into a wireless headset 101. It is important that when the Mic Disconnect Relay 607 is in an un-powered state that it disconnect Mono Rx Module A1 from the MIC/Power 501 signal to prevent interference with the wired signal from the retractable bypass cord 103.

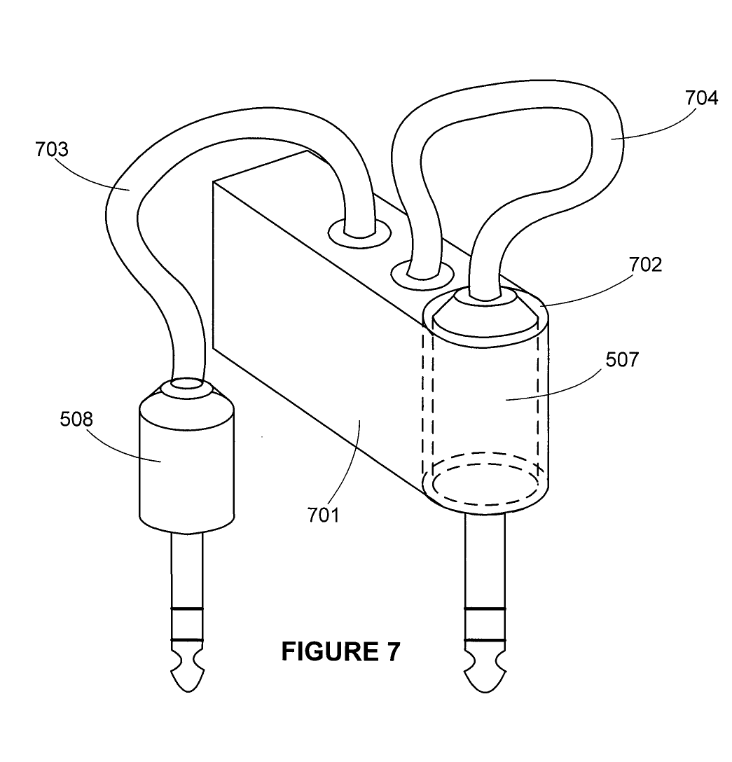

FIG. 7 illustrates a wireless transceiver enclosure 701 designed for compatibility with the physical placement of a wide variety of headphone jacks 107 and microphone jacks 108 (FIG. 1). In vehicles such as aircraft or fire trucks, the headphone jacks 107 and microphone jacks 108 are intended to work with headphones which have long cords and small plugs. Thus, the headphone jacks 107 and microphone jacks 108 in such vehicles are typically not designed for use with a small box such as a wireless transceiver. Consequently, the spacing between the headphone jacks 107 and the microphone jacks 108 is not consistent and often protrusions such as knobs or buttons are in close proximity to the jacks since the jacks are often mounted on a control panel of the vehicle. These protrusions may not interfere with plugging a cord into the jack, but often they do interfere with placing a wireless transceiver close against the jack. An undesirable solution is to place the wireless transceiver on a long enough cord to get the wireless transceiver away from the jacks where physical space is tight. This method defeats some advantages of a cordless solution, and unless the wireless transceiver is securely mounted, there is high likelihood that the wireless transceiver will dangle or shift about the cabin and get in the way. It is desirable that a portable wireless transceiver would avoid special mounting or installation requirements when possible, and provide maximum compatibility with existing headphone jacks 107 and microphone jacks 108.

As illustrated in FIG. 7, the wireless transceiver enclosure 701 includes a plug holding cylinder 702 to hold the wireless transceiver enclosure 701 securely to the headphone plug 507 so that the wireless transceiver enclosure 701 is mounted as closely to the headphone jack 107 as possible and does not shift about the vehicle cabin. The plug holding cylinder 702 is lined with rubber to provide enough friction and pressure on the headphone plug 507 to grip the headphone plug 507 securely even when the wireless transceiver enclosure 701 is used in an acrobatic aircraft. An alternative to using a rubber-lined cylinder would be to use a clamp or other method which adjusts the size of the plug holding cylinder 702. The plug holding cylinder 702 is placed at the very end of the wireless transceiver enclosure 701 so that the wireless transceiver enclosure 701 overhangs on only one side of the headphone plug 507, thus minimizing the possibility that a knob or button or other protrusion in the panel will prevent the wireless transceiver enclosure 701 and headphone plug 507 from inserting into the headphone jack 107 at some rotational angle. The microphone plug 508 is able to move freely on the microphone cord 703 in order to plug into a jack with unknown spacing with respect to the headphone jack.

This mounting method may also work by mounting the wireless transceiver enclosure 701 to the microphone plug 508 instead of the headphone plug 507, and letting the headphone plug 507 move freely on a cord. The headphone plug 507 is preferable since it is larger in diameter and can hold more weight than the microphone plug 508. No tether or latch is required if the wireless transceiver enclosure 701 is light weight, such as a wireless transceiver enclosure 701 that does not house a retractable bypass cord 103. A heavier wireless transceiver enclosure 701, especially one with the retractable bypass cord 103 may require a tether 106 as shown in FIG. 3, or a spring-steel jack latch 203 combined with a latch ring 109 on the headphone plug 507.

The vehicle may have so many knobs or other protrusions around the headphone jack 107 or microphone jack 108 that the wireless transceiver enclosure 701 cannot be mounted on the headphone plug 507. In such case, the headphone plug 507 may be removed from the plug holding cylinder 702, which may cause the wireless transceiver enclosure to dangle from its headphone cord 704 and microphone cord 703, which are typically just slightly longer than the length of the headphone plug 507 from tip to cord. When the headphone plug is removed from the plug holding cylinder 702, the wireless transceiver enclosure 701, though dangling, may still be used without mounting in some vehicles, and with mounting in others such as acrobatic aircraft. Hook and loop fasteners, such as Velcro may be used as a temporary mounting method. A Tether Cord 301 as shown in FIG. 3 may also be used in locations when it is acceptable for the wireless transceiver enclosure 701 to dangle.

Turning now to FIG. 8, a block diagram of the power management circuits and major components of the wireless headset 101 is illustrated. A Digital Stereo Receiver 806 receives wireless audio transmissions from the wireless transceiver 102 with retractable bypass cord 103. After decompressing the packetized audio transmissions and converting them back to analog using common digital wireless audio technology, the Digital Stereo Receiver 806 drives the Left Speaker 503 and Right Speaker 504 with the original audio signal from the radio or intercom 105.

The Digital Stereo Receiver 806 also receives battery status signals 817, 818, 819, and 820 from a battery charger and status unit 801. The battery status signals 817, 818, 819, and 820 provide the Digital Stereo Receiver 806 with battery charge status conditions of Full, Medium, Low, or Very Low charge. The Digital Stereo Receiver 806 uses these signals to trigger the insertion of battery status messages into the outgoing audio driver. These messages notify the wearer of the wireless headset 101 in advance if the headset battery 802 is about to die so that he or she has time to pull out the retractable bypass cord 103 and insert it into the wireless headset 101. FIG. 9 and FIG. 10 to follow provide more detail on how these audio messages are inserted without interrupting communications with ATC or another destination.

The Left SPKR Assembly 821 and Right SPKR assembly 822 each contain a driver 827 and 828 respectively that is directly driven by the Digital Stereo Receiver 806 or the retractable bypass cord 103 Left Speaker 504 and Right Speaker 503. The Left SPKR Assembly 821 and Right SPKR assembly 822 also each contain an anti-noise driver 825 and 826 driven by the Active Noise Reduction (ANR) unit 805. The ANR unit 805 generates an anti-noise signal in order to cancel out any noise present in the Left and Right speaker assemblies 821 and 822. The Left SPKR Assembly 821 and Right SPKR assembly 822 each may further contain a microphone 829 and 830 for feeding a noise-plus-audio signal back to the ANR unit 805, which the ANR unit 805 uses to create the anti-noise signal.

ANR circuits are well known in the art as demonstrated by U.S. Pat. No. 5,675,658. Although noise canceling may be performed electronically with a single driver instead of acoustically using two drivers, an advantage of using a separate driver in each speaker assembly for noise canceling is that if the ANR circuits fail, normal audio is still heard from the Left Driver 827 and Right Driver 828, which have no active electronics between them and the radio or intercom 105 when the retractable bypass cable 103 is used. Optionally, instead of using two drivers in the Left Speaker Assembly 821 and Right Speaker Assembly 822, each speaker assembly may use a dual voice-coil driver where one voice coil is driven by the audio signal and the other voice coil is driven by the anti-noise signal. Like the dual driver approach, the dual voice-coil approach also carries the advantage of eliminating active electronics from the audio signal path when the retractable bypass cord 103 is used. The dual voice-coil approach reduces weight associated with a second driver.

When the retractable bypass cord 103 is not plugged into the 5-conductor jack with latch 111, an Analog Transmitter 809 transmits voice from an Electret Microphone 814 to the wireless transceiver 102 with retractable bypass cord 103 or another wireless transceiver. An analog transmitter is used in some embodiments instead of digital because voice only requires 3 KHz of bandwidth, thus the RF bandwidth requirements are small and the digital logic associated with packetized transmissions consume more power and incur more audio delay than a simple analog transmission. The Analog Transmitter 809 will typically have a user selectable Channel ID so that it transmits on the frequency expected by the Wireless Transceiver 102 with retractable bypass cord 103. The Analog Transmitter 809 receives a voice signal 831 and a Tx On/Off signal 832 from a VOX 810, which provides squelch control so that the Analog Transmitter 809 is not transmitting when the user is not speaking, thus conserving power. The VOX 810 receives voice signal 831 from a preamp 815 through DC blocking capacitors 811. The preamp 815 is powered by the Tx/Rx PWR 813 through a current limiting resistor 812 when wireless transmissions are used. When the retractable bypass cord 103 is used, the preamp 815 is powered by the MIC/Power 501 through a low ohm resistor 808.

The battery charger and status unit 801 charges the headset battery 802 using the power input from the MIC/Power 501 signal, which comes from the radio or intercom 105 when the retractable bypass cord 103 is plugged in, or from a power supply which provides power using a plug compatible with the 5-conductor jack with latch 111. Battery charging circuitry, which is well known in the art, is used to ensure that the battery charger and status unit 801 does not overcharge the battery 802. The battery charger and status unit 801 draws as much current as the headset battery 802 needs to charge quickly and safely, or the maximum current the power supply or MIC/Power 501 provides, whichever is smaller. MIC/Power 501 from a radio or intercom 105 typically provides 12V through a 1K ohm resistor, limiting the current to about 6 mA usable at 6V.

The battery charger and status unit 801 typically uses a 6V zener diode as a voltage reference for a voltage regulator to set the voltage drop from the MIC/Power 501 so that the maximum possible current is drawn from MIC/Power 501 without drawing so much current that the MIC/Power 501 voltage drops below the 6V needed to supplement the headset battery 802 or power the preamp 815. Six mA is typically enough to supplement the headset battery 802 and lengthen the operating time of a battery powered headset, but not enough to charge the headset battery 802 while the ANR unit 805, Digital Stereo Receiver 806, VOX 810, Analog Transmitter 809, and Preamp 815 are in use. When connected to a higher current MIC/Power 501 source such as a power supply, the battery charger and status unit 801 may draw sufficient current to quickly and safely charge the headset battery 802. In addition to providing headset battery status signals 817, 818, 819, and 820 to the Digital Stereo Receiver 806, the battery charger and status unit 801 also drives LEDs (not illustrated) that provide visual status of headset battery 802 power.

A Power Distribution unit 803 enables and disables headset power 823 to ANR unit 805 through the ANR PWR 824 bus, and also enables or disables headset power 823 to the Digital Stereo Receiver 806, Analog Transmitter 809, VOX 810, and Preamp 815 through the TX/RX PWR 813 bus. The Power Distribution unit 803 intelligently provides power based on a number of monitored conditions including battery status, audio inactivity, presence of the retractable bypass cord 103, and a user's request for power on or off via momentary Power Button 804.

The presence of the retractable bypass cord 103 is detected when the PWR Present signal 816 is asserted due to DC current being sensed on the MIC/Power 501 signal of the retractable bypass cord 103. The PWR Present signal 816 is asserted when current drawn by the preamp 815 causes a small voltage drop across a low ohm resistor 808, which is in series with the MIC/Power 501 from the retractable bypass cord 103. The small voltage drop is detected by a comparator 807 which then asserts the PWR Present signal 816.

The presence of the retractable bypass cord 103 as provided by PWR Present signal 816 causes Power Distribution unit 803 to disable headset power 823 to the Digital Stereo Receiver 806, Analog Transmitter 809, VOX 810, and preamp 815, by disabling the Tx/Rx PWR power bus 813. ANR Power 824 is provided even when the retractable bypass cord 103 is connected if battery status signals Full 817 or Medium 818 are asserted. When battery status Very Low 820 is asserted, both ANR PWR 824 and Tx/Rx PWR 813 are disabled to prevent damaging the headset battery 802. When battery status Low 819 is asserted, ANR PWR 824 is enabled when PWR Present 816 is asserted, and is disabled when PWR Present 816 is de-asserted.

The momentary Power Button 804 may be pressed by a user to power up the wireless headset 101 when power is off, and is also pressed to turn off the wireless headset 101 when power is on, except when after the Shutdown Warning 918 (FIG. 9) flag is asserted. When the momentary Power Button 804 is pressed and battery status Very Low 820 is asserted, power is enabled momentarily to allow the user to see the battery status LED's or hear a battery status message, and then shut off again automatically after a few seconds to prevent damage to the headset battery 802

The ANR PWR 824 and Tx/Rx PWR 813 are shutoff automatically by power distribution unit 803 when the Inactive 833 signal is asserted. This feature saves battery power by assuming that a user forgot to power off the wireless headset 101 when finished using it. This assumption is based on the absence of any audible signal received by the Digital Stereo Receiver 806 for a user selected period of 10 or 20 minutes. Approximately twenty seconds before asserting the Inactive 833 signal, the Digital Stereo Receiver 806 audibly notifies the user that he or she must press the Power Button 804 in order to maintain power, which is a safeguard in case the inactivity assumption is false.

Referring now to FIG. 9, details of a Digital Stereo Transmitter and Digital Stereo Receiver, such as those previously disclosed, will be described. A wireless audio processor, such as the XInC2, which is a commercially available product of Eleven Engineering, having offices at 10150-100 Street, Suite 900 Edmonton, Alberta, Canada, T5J 0P6, is used as the Transmitter Processor 901 and Receiver Processor 910 and provides hardware support for up to eight separate software threads which each run in parallel in real time without interrupts from the other threads. This parallel processing architecture simplifies many of the operations discussed below, which are implemented as stand-alone threads.

A stereo A-to-D Converter 902 may be implemented using a Cirrus Logic CS5341, which is commercially available from Cirrus Logic, Inc., having offices at 2901 Via Fortuna, Austin, Tex., 78746, USA, to convert the analog Left Speaker 504 and Right Speaker 503 to digital signals for processing by a Transmitter Processor 901. The Transmitter Processor 901 uses one thread as the Stereo Compressor 903 or “codec”, another thread as the Packetizer 904, and another thread for Transmitter Baseband Control 905. These functions are well known in the field of digital wireless audio. Another thread functions as the Transmitter Message Inserter (MSG) 907 which inserts Complete Packetized Messages 1006 (FIG. 10) into the outgoing audio stream without interrupting communications by monitoring the status of a Transmit Sound Detected 922 flag provided by the Stereo Compressor 903 thread.

The Stereo Compressor 903 thread compresses the audio amplitude as part of a compression algorithm and sets the Transmit Sound Detected 922 flag according to the audio amplitude, similar to a squelch circuit. When Battery Status 515 indicates that the Transceiver Battery 511 is Low or Very Low, the appropriate message to a user is retrieved from Transmitter EPROM or other persistent memory 908 by Transmitter Message Inserter 907 and provided to Transmitter Baseband Control 905 for transmission using the sequence shown in FIG. 11, which avoids interrupting communications originating from the Left Speaker 504 and Right Speaker 503 inputs.

The Transmitter Baseband Control 905 handles configuration of the Transmitter RF Module 906, data transfer, and provides error handling of dropped packets. The Transmitter Baseband Control 905 configures the Transmitter RF Module 906 to only link up with a Receiver RF Module with the same ID 909 as the Transmitter RF Module 906 has. Three dip switches (not illustrated) are set by the user to select the ID 909 in order to pair the transmitter to the same ID as the wireless headset 101.

The Receiver Processor 910 in the Digital Stereo Receiver 806 may be the same processor used for the Transmitter Processor 901, and performs both similar functions and inverse functions. The Receiver Processor 910 uses one thread as the Receiver Baseband Control 912, another thread as the Depacketizer 913, and another thread for the Stereo Decompressor 914. Another thread functions as the Receiver Message Inserter 919, which inserts Complete Packetized Messages 1006 into the outgoing audio stream without interrupting communications by monitoring the status of a Receive Sound Detected 922 flag provided by the Decompressor thread 914.

The Decompressor 914 thread decompresses the audio amplitude as part of the decompression algorithm and sets the Receive Sound Detected 922 flag according to the audio amplitude, similar to a squelch circuit. Decompressed digital audio from the Decompressor 914 is sent to a stereo D-to-A Converter 915 implemented with a Cirrus Logic CS4341, which is commercially available from Cirrus Logic, Inc., having offices at 2901 Via Fortuna, Austin, Tex., 78746, USA, which converts the digital audio back to analog. The right and left analog audio is then amplified by dual Amps 920 and driven onto the Left Speaker 504 and Right Speaker 503 signals which drive the Left Driver 827 and Right Driver 828. When battery status Low 819 or Very Low 820 are asserted, or the Shutdown Warning 918 flag is asserted by the Inactivity Timer 916, the appropriate message for the user is retrieved from Receiver EPROM 917 by the Receiver Message Inserter 919 thread and provided to the Depacketizer 913 using the sequence shown in FIG. 11, which avoids interrupting communications originating from the Receiver RF Module 911 input.

The Inactivity Timer 916 resets to zero whenever the Receive Sound Detected 923 flag is asserted by the Decompress 914 thread. The Inactivity Timer 916 is programmable via a dip switch (not illustrated) to time for 10 or 20 minutes or some other desirable time. Approximately twenty seconds before the Inactivity Timer 916 reaches its termination count, it asserts the Shutdown Warning 918 flag to cause a warning message to be sent to the user by the Receiver Message Inserter 919 thread, which tells the user to press the power button 804 to abort the shut down. The Inactivity Timer 916 senses the Button Pushed 834 signal and resets to zero if Button Pushed 834 is asserted while the Shutdown Warning 918 flag is asserted, thus aborting the power shutdown. The Receiver Message Inserter 919 thread also monitors whether the Receiver Baseband Control 912 has linked up with the Digital Stereo Transmitter 512 in a wireless transceiver, and inserts messages regarding link status into the outgoing audio stream until link up is complete.

Both the wireless transceiver 102 with retractable bypass cord 103 and the wireless headset 101 monitor the receive audio path and insert warning and status messages into the receive audio stream without interrupting communications. The receive audio path is the path from the radio or intercom 105 to the wireless headset 101. The transmit audio path from the wireless headset 101 to the radio or intercom is not monitored directly, but is still monitored as a result of a sidetone feature provided by the radio or intercom 105, which provides feedback of the microphones back into the headsets. Thus, status and warning messages are inserted without interrupting communications in either the receive audio path or the transmit audio path, even though the receive audio path is the only path being directly monitored.

The wireless transceiver 102 with retractable bypass cord 103 may insert the following voice messages into its outgoing stereo transmission without interrupting communications:
1) “Transceiver battery is low. Please use bypass cord.”
2) “Transceiver battery is very low. Wireless is shutting down. Please use bypass cord now.”

The wireless headset 101 may insert the following voice messages into the outgoing audio stream without interrupting communications:
1) “Headset battery low. Please use bypass cord to maintain noise canceling.”
2) “Headset battery is very low. Wireless is shutting down. Please use bypass cord now.”
3) “Headset inactivity timeout. Please press the power button to abort shut down.”
4) “The headset is linked to a wireless transceiver”.
5) “No wireless transceiver found. Please check transceiver batteries and connection to a powered microphone jack.”

FIG. 10 shows the format of status message packets. As illustrated, each Message Packet 1005 consists of fields including a Start-of-Packet 1001, a Header 1002, a Message Fragment 1003, and an End-of-Packet 1004. The Header 1002 field contains information distinguishing Message Packets 1005 from configuration and linking packets and other packets associated with digital wireless transfer. The Message Fragment 1003 field contains compressed digital audio which is ready for decompression by the Stereo Decompressor 914. In order to minimize the delay associated with normal digital wireless audio transmission, Message Fragments 1003 and packet sizes are kept small, containing less than a complete English word. A Complete Packetized Message 1006 requires many Message Packets 1005.

Referring now to FIG. 11, a sequence of steps used to insert status messages into the audio stream without interrupting communications in accordance with one embodiment of the present invention is illustrated. Note that the sequence of FIG. 11 is only one of several possible ways to insert status messages into the audio stream without interrupting communications and should not therefore be used to limit the appended claims.

Initially, the Message Inserter 907 or 919 thread determines in Pending Message Decision Block 1007 if there is a pending status message. If there is no pending message (NO in decision block 1007), then the Message Inserter 907 or 919 thread continues to monitor for a pending message. When it is determined that a status message needs to be sent to a headset user (YES in decision block 1007), the Message Inserter 907 or 919 thread proceeds to Initialize MSG Packet Pointer 1008, which is an address pointer used by the Message Inserter 907 or 919 thread to keep track of which packet is sent next. The Message Inserter 907 or 919 thread will then Wait 2 Seconds 1009 and determine in the Sound Detected Flag Decision Block 1010 if the Sound Detected Flag is detected to see if any communications audio is in progress which should not be interrupted. The Sound Detected Flag is also shown in FIG. 9 as Transmit Sound Detected 922 and Receive Sound Detected 923.

If the Sound Detected Flag is set (Yes in decision block 1010), the Message Inserter 907 or 919 thread loops back to again Initialize MSG Packet Pointer 1008. If the Sound Detected Flag is cleared (NO in decision block 1010), a Message Packet is Inserted 1011 and is sent out to Transmitter Baseband Control 905 by the Transmit Message Inserter 907 or provided to the Decompressor 914 thread by the Receiver Message Inserter 919. The Message Inserter 907 or 919 thread will then Increment Packet Pointer 1012 and then determine in the Last MSG Packet Decision Block 1013 if the Last MSG Packet is Sent as indicated by the packet pointer being greater than the last packet in the Complete Packetized Message 1006.

If the last Message Packet 1005 in the Complete Packetized Message 1006 has not been sent (NO in decision block 1013), the Message Inserter 907 or 919 thread will loop back to check the Sound Detected Flag 1010 in case any communications from the radio or intercom 105 or the Electret Microphone 814 have come in which would cause the message to be aborted in favor of communications. If the last Message Packet 1005 in the Complete Packetized Message 1006 has been sent (Yes in decision block 1013), the Message Inserter 907 or 919 thread is done and goes back to the Pending Message Decision Block 1007.

Total delay from the A-to-D Converter 902 through the Digital Stereo Transmitter 512 through the Digital Stereo Receiver 806 and finally the D-to-A Converter 915 is kept under 20 ms in order to minimize echo. Echo results if the round-trip delay is long enough to be audible because of the sidetone provided by the radio or intercom 105. Sidetone is a feature which feeds the microphone audio back to the headset so that the user can hear himself or herself speak, which provides the user with confidence that others can hear them. Echo due to sidetone can be caused by delay in the path from the Electret Microphone 814 to the Radio or Intercom 105, or by delay in the path from the Radio or Intercom 105 to the Left Driver 827 and Right Driver 828.

Due to the fixed overhead of non-payload fields associated with packets such as the Header 1002 field, higher throughput is provided by larger payload fields, such as the Message Fragment 1003 field. Unfortunately, large payload fields also cause larger delays which result in echo due to sidetone. The throughput provided does not change linearly with payload size due to the fixed overhead, so the penalty for decreasing the delay from 40 ms to 20 ms is much more than twice the number of packets. Since there is a limited amount of RF bandwidth available in license-free bands, and because there may be multiple wireless headsets in a single cockpit all sharing the same license-free RF band using frequency hopping, it is critical to balance the tradeoff between sidetone echo caused by larger packet sizes, and higher RF bandwidth efficiency which results from larger packet sizes. Traditional digital wireless audio systems which provide full-duplex communications use digital technology in both directions. A novel approach to solving this problem in the wireless headset 101 is to eliminate delay between the microphone and the wireless transceiver by using analog transmission in a different RF band than that used by the Digital Stereo Transmitter 512 and Digital Stereo Receiver 806. Thus the digital delays are only incurred in one direction of the full-duplex communication path.

Although the present invention has been described above with respect to a wireless headset, this is for illustration only and should not be used to limit the scope of the appended claims. It is also anticipated that the principles of the present invention may apply to any wired or wireless headset or handset. A headset or a handset is defined to at least include any communication device that has an audio speaker that may be placed against a user's ear. Examples include, but are not limited to, wireless and wired headsets, cellular telephones, walkie/talkies, other hand held communication devices, or radios. In particular, the status message insertion method described above could be applied to any handset or headset that includes a microprocessor configured to insert status messages without interrupting normal communication.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A wireless communication system comprising:
a wireless headset or handset;
a wireless transceiver configured to communicate with the wireless headset or handset over a wireless signal path; and
a retractable bypass cord integrated with the wireless transceiver, wherein the retractable bypass cord is configured to connect the wireless transceiver with the wireless headset or handset such that the wireless signal path is bypassed with a wired signal path.

2. The wireless communication system in accordance with claim 1, wherein the wireless headset or handset is one of a cellular phone, a walkie/talkie, or a radio.

3. The wireless communication system in accordance with claim 1, wherein the wireless headset or handset includes a connector latch for latching the retractable bypass cord to the headset or handset, wherein the connector latch substantially prevents the retractable bypass cord from being inadvertently pulled out of the wireless headset or handset and is configured to allow insertion of the retractable bypass cord at any rotational angle.

4. The wireless communication system in accordance with claim 1, wherein the retractable bypass cord is connected in series with the wireless transceiver during wireless operation by connecting a connector of the retractable bypass cord into a connector of the wireless transceiver configured to receive the plug connector.

5. The wireless communication system in accordance with claim 4, wherein the retractable bypass cord is connected in series with the wireless headset or handset by disconnecting the connector of the retractable bypass cord from the wireless transceiver connector and connecting the retractable bypass cord connector into a connector of the wireless headset or handset configured to receive the retractable bypass cord connector for wired operation of the wireless headset or handset.

6. The wireless communication system in accordance with claim 1, wherein the wireless transceiver includes a retractable cord reel configured to store the retractable bypass cord.

7. The wireless communication system in accordance with claim 1, wherein the retractable bypass cord includes a connector on the retractable bypass cord configured to plug into a corresponding connector of the wireless transceiver or the wireless headset or handset at any rotational angle and wherein the retractable bypass cord connector includes a latch that substantially secures the retractable bypass cord connector.

8. The wireless communication system in accordance with claim 7, wherein the plug connector includes speaker connections and power connections for transmitting audio or power signals from an external radio or intercom to the wireless transceiver or wireless headset or handset.

9. The wireless communication system in accordance with claim 1, wherein the retractable bypass cord is connected in parallel with the wireless transceiver during wireless operation such that connecting the retractable bypass cord to the wireless headset or handset does not bypass any wireless communication between the wireless transceiver and a second wireless headset or handset.

10. The wireless communication system in accordance with claim 1, wherein the retractable bypass cord adapts signals from separate microphone and headphone jacks of an intercom or radio separate from the wireless transceiver into a single connector such that the signals from the microphone and headset jacks can be made to the wireless headset or handset or the wireless transceiver with the single connector of the retractable bypass cord.

11. The wireless communication system in accordance with claim 1, wherein the wireless transceiver is secured by a jack latch to a jack that is connected to an intercom or radio separate from the wireless transceiver such that the retractable bypass cord is not pulled out during operation.

12. The wireless communication system in accordance with claim 1, wherein the wireless transceiver is configured to send audible status messages regarding operational parameters of the wireless transceiver to the wireless headset or handset without interrupting normal communications between the wireless transceiver and the wireless headset or handset by delaying sending a status message to the wireless headset or handset until after some time period has elapsed after a communication received from the wireless headset or handset and by instantly terminating a status message in progress when a communication is received from the wireless transceiver.

13. A wireless communication system comprising:
a wireless transceiver configured to communicate with a wireless headset or handset over a wireless signal path; and
a detachable tether system coupled to the wireless transceiver.

14. The wireless communication system in accordance with claim 13, wherein the detachable tether system secures the wireless transceiver to a jack that is connected to an intercom or radio separate from the wireless transceiver.

15 The wireless communication system in accordance with claim 13, wherein the detachable tether system includes a tether cord coupled to the wireless transceiver and a tether clip for coupling to a jack that is connected to an intercom or radio separate from the wireless transceiver.

16. The wireless communication system in accordance with claim 15, wherein the detachable tether system further includes a tether connection means that is configured to have a first portion coupled to the jack and a second portion that provides a hole or a feature that the tether clip can clip on to.

17. A wireless transceiver for use in wireless communication with a wireless headset or handset comprising:
an integrated retractable bypass cord configured to connect the wireless transceiver with the wireless headset or handset such that a wireless signal path is bypassed with a wired signal path;
a first connector for receiving a retractable bypass cord connector; and
one or more second connectors coupled to at least one of the retractable bypass cord or the wireless transceiver for receiving audio and power signals from an intercom or radio that is separate from the wireless transceiver.

18. The wireless transceiver in accordance with claim 17, wherein the one or more second connectors receive left and right audio speaker signals, the wireless transceiver further comprising a stereo mono switch configured to electrically connect the left and right speaker signals together so that the wireless transceiver may be used with stereo or mono radios or intercoms.

19. The wireless transceiver in accordance with claim 17 further comprising a battery charger and power distribution module for charging batteries of the wireless transceiver, wherein the battery charger and power distribution module is coupled to the first connector.

20. The wireless transceiver in accordance with claim 19, wherein one of the one or more second connectors is a microphone connector that provides microphone power from the intercom or radio that is separate from the wireless transceiver to the battery and charger distribution module for charging the wireless transceiver batteries via the retractable bypass cord and first connector.

21. The wireless transceiver in accordance with claim 17 further comprising a digital stereo transmitter for transmitting audio signals received from the one or more connectors via the retractable bypass cord and first connector.

22. The wireless transceiver in accordance with claim 21, wherein the digital stereo transmitter is configured to receive battery status signals regarding the power status of a battery of the wireless transceiver from a battery charger and power distribution module and transmit the status signals to the wireless headset or handset to inform a user of the power status of the battery.

23. The wireless transceiver in accordance with claim 17, wherein the wireless headset or handset is one of a wireless headset, a cellular phone, a walkie/talkie, or a radio.

24. A wireless transceiver for use in wireless communication with one or more wireless headsets or handsets comprising:
an integrated retractable bypass cord configured to connect the wireless transceiver with at least one of the one or more wireless headsets or handsets such that a wireless signal path is bypassed with a wired signal path;
detection circuitry for detecting when the retractable bypass cord is coupled to one of the one or more wireless headsets or handsets; and
one or more connectors coupled to the wireless transceiver for receiving audio or power signals from an intercom or radio that is separate from the wireless transceiver.

25. The wireless transceiver in accordance with claim 24, wherein upon detection by the detection circuitry that the retractable bypass cord has been connected to one of the one or more wireless headsets or handsets, the transceiver automatically begins to transmit the audio or power signals via the retractable bypass cord.

26. The wireless transceiver in accordance with claim 25, wherein the wireless transceiver continues to transmit the audio signals by wireless transmission to those wireless headsets or handsets of the one or more wireless headsets or handsets that were not connected to the retractable bypass cord.

27. The wireless transceiver in accordance with claim 24, wherein the detection circuitry detects that the retractable bypass cord has been connected to one of the one or more wireless headsets or handsets by detecting a current being drawn by the wireless headset or handset connected to the retractable bypass cord.

28. The wireless transceiver in accordance with claim 24, wherein the one or more wireless headsets or handsets are one of a wireless headset, a cellular phone, a walkie/talkie, or a radio.

29. The wireless transceiver in accordance with claim 24, wherein the one or more connectors receive left and right audio speaker signals, the wireless transceiver further comprising a stereo mono switch configured to electrically connect the left and right speaker signals together so that the wireless transceiver may be used with stereo or mono radios or intercoms.

30. The wireless transceiver in accordance with claim 24 further comprising a battery charger and power distribution module for charging a battery of the wireless transceiver.

31. The wireless transceiver in accordance with claim 30, wherein one of the one or more connectors is a microphone connector that provides microphone power from the external radio or intercom to the battery and charger distribution module for charging the wireless transceiver battery.

32. The wireless transceiver in accordance with claim 24 further comprising a digital stereo transmitter for transmitting audio signals received from the one or more connectors.

33. The wireless transceiver in accordance with claim 32, wherein the digital stereo transmitter is configured to receive battery status signals regarding the power status of a battery of the wireless transceiver from a battery charger and power distribution module and transmit the status signals to the wireless headset or handset to inform a user of the power status of the battery.

34. In a wireless transceiver including a microprocessor for executing software configured to provide status messages regarding operational parameters of the wireless transceiver to a user of the wireless transceiver, a method for inserting status messages regarding the operational parameters without interrupting normal communication of the wireless transceiver, the method comprising:
determining if there is a pending status message;
determining if any normal audio communications are present;
in response to determining that normal audio communications are present, not inserting the status message until the normal audio communications are complete; and
in response to determining that normal audio communications are not present, inserting the status message into an audio communication.

35. The method in accordance with claim 34, wherein the method is repeated for subsequent status messages.

36. A wireless communication system comprising:
a wireless transceiver;
one or more connectors coupled to the wireless transceiver via electrical cords; and
a transceiver housing configured to mechanically secure the wireless transceiver to a connector housing of at least one of the one or more connectors.

37. The wireless communication system in accordance with claim 36, wherein the transceiver housing includes a rubber lined cylinder that provides friction between the rubber and the connector housing.

38. The wireless communication system in accordance with claim 36, wherein the transceiver housing includes clamping means for clamping to the connector housing.

39. The wireless transceiver in accordance with claim 36, wherein the one or more connectors comprise a first connector and a second connector, wherein the wireless transceiver housing mounts the first connector housing at the physical end of the wireless transceiver such that over 66% of the wireless transceiver is on one side of the first connector and less than 34% of the wireless transceiver is on the other side of the first connector while the second connector is not mounted to the wireless transceiver housing but is flexibly connected to the wireless transceiver using a multi-conductor cable.
